(19) United States
(12) Patent Application Publication
(10) Pub. No.: US 2004/0213958 A1
(43) Pub. Date: Oct. 28, 2004

(54) Method of laminating decorative fabric to hard, smooth substrates and product thereof

(76) Inventor: Maureen Martin, West Allis, WI (US)

Correspondence Address: QUARLES & BRADY LLP, 411 E. WISCONSIN AVENUE, SUITE 2040, MILWAUKEE, WI, 53202-4497, US

(21) Appl. No.: 10/827,198

(22) Filed: Apr. 19, 2004

Related U.S. Application Data
(60) Provisional application No. 60/465,251, filed on Apr. 24, 2003.

(51) Int. Cl. B32B 3/00

(52) U.S. Cl. 428/142; 156/267; 156/278; 428/187; 428/207

(57) ABSTRACT

A method of making a decorative item comprises providing a transparent glass substrate, providing a portion of decorative material large enough to cover one side of the glass substrate, applying an adhesive sealant to one side of the material, adhering the side of the material with the adhesive to a bottom side of the transparent glass substrate, so as to be visible therethrough, trimming the material around an edge of the substrate, smoothing the edge of the substrate where the material was trimmed, applying a transparent, glossy, resilient coating material over the bottom of the substrate with the decorative material adhered in place, allowing the coating material to cure, and executing a finishing operation to smooth the edge after the resilient coating has been applied. A product made with the process is also disclosed.

### TECHNICAL FIELD

The field of the invention relates to an improved decorative plate and method of making the same, and in particular a decorative plate in which a decorative fabric is laminated to a hard, smooth substrate such as a glass plate. The invention can also be applied to other types of articles as more particularly described below.

### BACKGROUND OF THE INVENTION

Methods of decorating plates and dishes by hand painting have been well known for centuries. Decorative plates have been sold as souvenirs in gift shops, tourist resorts and craft fairs. Part of the appeal of the decorative plates is the opportunity to decorate the plate in a unique way or as a limited edition, which sets it apart from mass-manufactured items.

### SUMMARY OF THE INVENTION

The present invention relates to a method of assembling a decorative fabric to a substrate, including applying adhesive and optionally glitter to the fabric, adhering the fabric to the substrate so that a top side of the fabric can be viewed from the top side of the assembly, and applying a high gloss transparent and waterproof finish coat to the encapsulate the fabric and the substrate, such that the decorative aspects of the fabric, including the glitter are visible to such an extent that they appear to be substantially integral with the substrate. The finish coat also provides a plate that is useable and cleanable in addition to being decorative.

Other aspects of the invention include details of the method which provide a surface without bubbles or imperfections.

Still other aspects of the invention will be apparent from the detailed description that follows, in which reference is made to the accompanying drawings, which form a part hereof, and which illustrate a preferred method of the invention, without intending to limit the invention beyond that which is enable by the drawings and description herein.

### BRIEF DESCRIPTION OF THE DRAWINGS

FIGS. 1-9 are perspective views illustrating the acts in a preferred method of the present invention.

### DETAILED DESCRIPTION

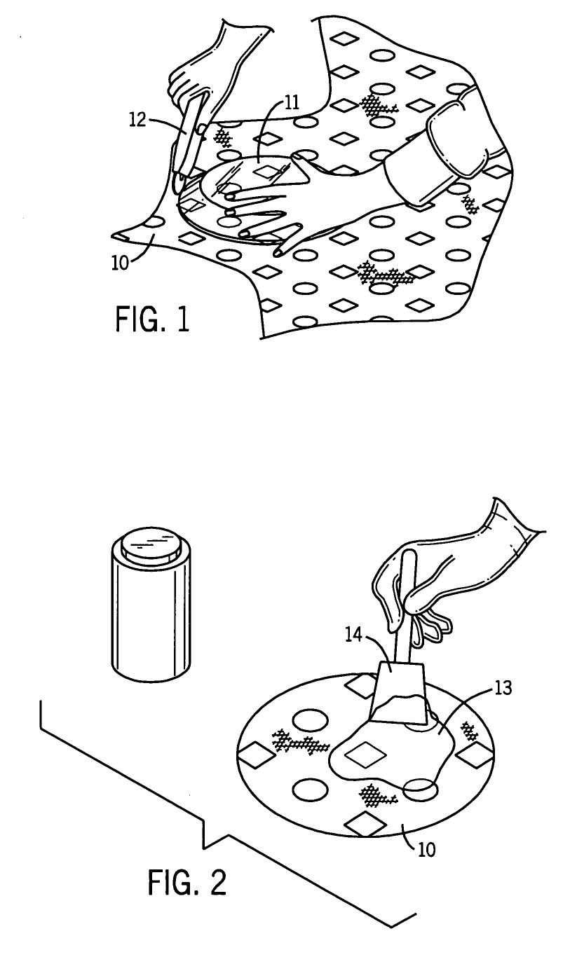

Referring to FIG. 1 of the drawings, for an illustrative example of the invention, a plate of clear glass is selected as the substrate. Wherever the term “clear” is used herein, it shall be understood to mean both transparent and substantially colorless. The plate could be of various sizes, including a salad plate, a dinner plate or a platter, but in this example, a dinner plate is used. As a preparatory activity, the plate is washed, cleaned and dried.

To this substrate, the invention provides a method of attaching, securing and coating a decorative fabric, the term “decorative” relating to color, pattern or other decoration. The fabric is preferably 100% cotton or a polyester blend, which includes bandanas, napkins and doilies.

As shown in FIG. 1, the fabric 10 is cut to the size of the plate 11 plus 1 inch using a suitable cutting instrument 12.

Next, as shown in FIG. 2, working in a well-ventilated area, an adhesive 13, preferably of the type sold under the trademark Mod Podge®, Gloss Lustre, is applied with a sponge brush 14 over the top (obverse) side of the material 10, which will be visible from the top of the plate. The adhesive is a water-based sealer, glue and finish for all surfaces, similar to a white glue.

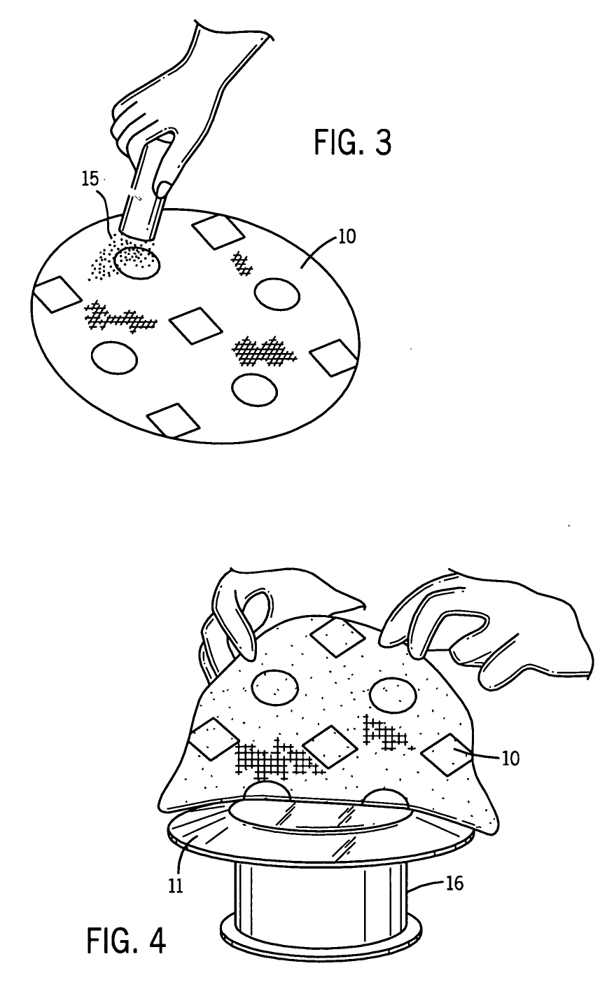

Then, as seen in FIG. 3, glitter 15 can be added by from a container by sprinkling it on the side of the fabric having the adhesive applied to it. Several types or colors of glitter may be applied to provide aesthetic decoration.

Next, as seen in FIG. 4, the glass plate 11 is inverted and elevated on a cylindrical supporting object 16 to make it easy to work on. Working on the back side of the clear plate, the coated material 10 is placed top side down over the back of the plate 11, so that the coated side with glitter will be viewed through the transparent plate. The excess fabric around the edges will drape down from the elevated plate.

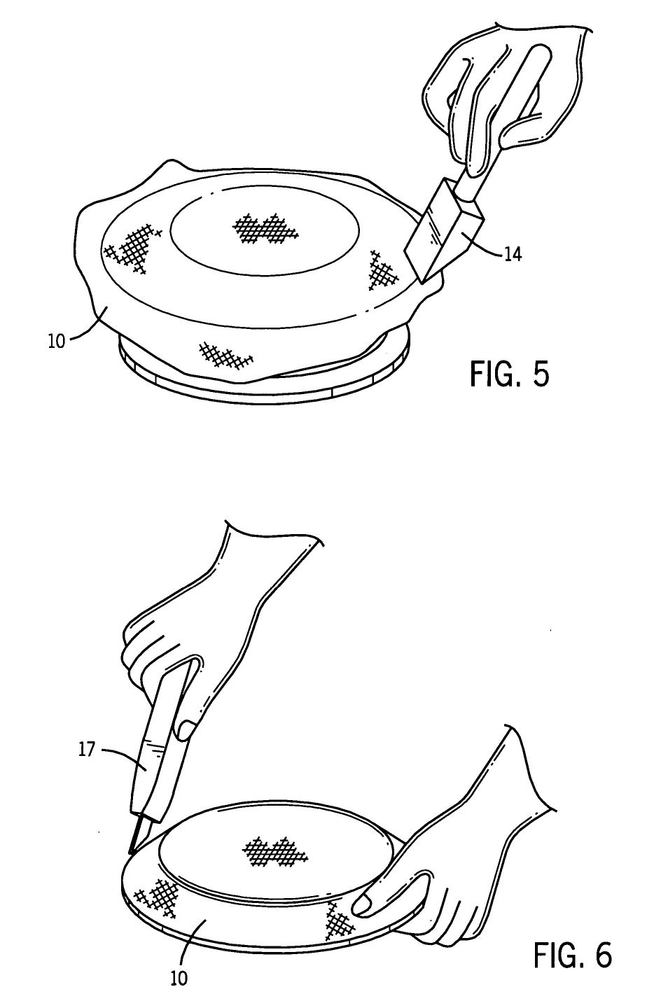

While wearing rubber gloves, a person should work the material tightly over the back of the plate with the hands. Additional adhesive is applied with the sponge brush 14 to the back of the material 10 as shown in FIG. 5. The adhesive, which is also a sealant, will soak through the material. Using the brush, the fabric should be flattened and smoothed, using the fingers to create a tight bond between material and plate. More of the adhesive should be applied as needed. The extra 1 inch of material is turned to the front side of the plate, running the fingers over the edge to insure a tight bond. The material is laid flat against the back of the plate. The material is pulled tight and flat across the bottom of the plate and around its edges. The plate should be left to dry inverted on a cylinder type of object for approximately 2-5 hours.

When dry, the extra fabric 10 is cut away with a straight edge 17 using the edge of the plate, as seen in FIG. 6.

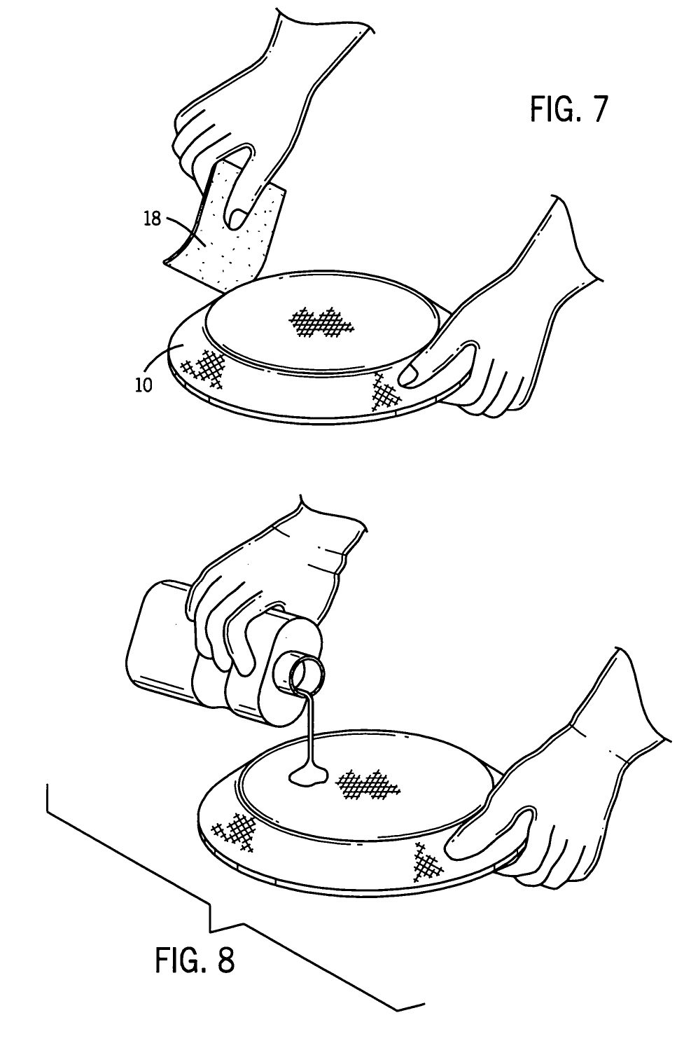

Then, using a sanding pad 18, the edge of the material 10 is sanded along the edge of the plate as seen in FIG. 7. The fabric edge should be flush with the glass.

The plate is now ready for the finish coat of a high gloss, transparent material which will also waterproof the plate in the process.

Appropriate amounts of a clear, high gloss, resilient coating material, such as Envirotex Lite®, are mixed with a curing agent in a glass container in a well-ventilated area. This is a two-part system having a hardner containing nonyl Phenol, polyoxyalkyleneamines, and N-Aminoethylpiperazine and a resin containing Bisphenol/A/epichlorohydrin resin and aliphatic and aromatic glycidyl ethers.

This must be undertaken with special chemical-resistant gloves, protection against inhalation and safety glasses according to the manufacturer's instructions for using the product. Using a sponge brush, apply Envirotex Lite® evenly over the back side of the fabric-covered plate as shown in FIG. 8. Move the sponge brush along the edge of the plate to seal the edge.

Place the plate upside down on a cylinder type object on a shelving unit that has been covered with paper. Using a propane torch, run the flame over the finish coated plate to burst any air bubbles that exist. Allow the coating on the plate to dry in a 70-degree or higher dust free environment. The finish coating will drip off of the plate as it is drying. Allow to dry for 8 hours in a controlled environment. Then allow to cure for another 3 days and according to the manufacturer's specification.

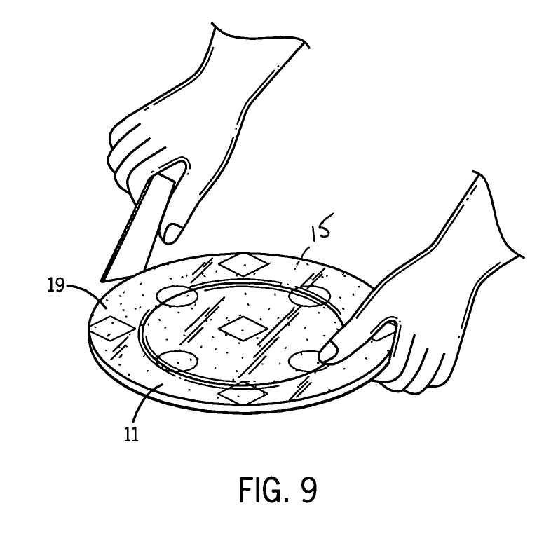

Next, cut away excess finish coating material from the lip 19 of the plate 11 as shown in FIG. 9.

Then, the plate for 2-3 hours is soaked in a bath of warm water to insure that it is waterproof. This will also soften the bumps that have formed from the finish material dripping over the sides of the plate. Take plate out of warm water, dry with towel and cut the bumps off of the front side of the plate, following the lip of the plate. Scrape the front of the glass plate to remove any residue of the adhesive or the finish material.

A second coat of the finish material may be applied, if needed. After the surface is prepared by wiping with a clean cloth and alcohol prior to applying the second coat, the steps for applying the first coat are repeated.

When the finish is suitable, the front and back of the plate can be cleaned with a glass cleaner. The finished product is then inspected to insure that the fabric adhered to the glass plate and that defects do not exist in the finished product.

Having described the invention with respect to a preferred embodiment, it also applicable to substrates such as bowls, platters, cutting boards (made out of glass), regular glass, as well as to metals and non-transparent glass. The method can be used to attach fabric, napkin, newspaper print, magazine articles, greeting cards, wrapping paper, etc. can be applied to the front of non-clear objects and then sealed with the waterproof sealer.

This method can be applied to, but not limited to: counter tops, TV trays, tables, paneling, coasters, boxes, or to any wood, metal or glass article.

The resulting product is waterproof for purposes of washing by hand with water of a temperature typical of hand washing.

1. A method of making a decorative item, comprising:
providing a transparent substrate;
providing a portion of decorative material large enough to cover one side of the transparent substrate;
applying a water-based sealant and adhesive to at least one side of the material;
adhering the material with the adhesive to a bottom side of the transparent substrate, so as to be visible through the substrate;
applying a transparent, glossy, resilient coating material over the bottom of the substrate with the decorative material adhered in place;
allowing the coating material to cure; and
executing at least one operation to smooth an edge of the substrate which meets an edge of the material and an edge of the coating material

2. The method of claim 1, wherein after applying and finishing the resilient coating material, the decorative material appears to be substantially integral with the substrate.

3. The method of claim 1, wherein after applying and finishing the coating material, a resulting assembly is waterproof for purposes of washing by hand.

4. The method of claim 1, further comprising after applying the adhesive to the material, sprinkling glitter on the material before it is adhered to the substrate.

5. The method of claim 1, further comprising turning the material over and applying a water-based sealant and adhesive to a second side of the material, and wherein the material is then adhered to the substrate.

6. The method of claim 1, wherein after adhering the material with the adhesive to the substrate,
trimming the material around an edge of the substrate; and
smoothing the edge of the substrate where the material was trimmed.

7. The method of claim 1, wherein the operation to smooth the edge further comprises trimming the edge of the assembly with a cutting instrument after the coating material has cured.

8. The method of claim 1, wherein after the coating material has cured, heat is applied to remove any bubbles formed in the coating material.

9. The method of claim 1, wherein after the coating material has cured, a resulting product is soaked in a warm bath of water.

10. The method of claim 1, wherein the decorative material is fabric or paper.

11. The method of claim 10, wherein the decorative material is a bandana.

12. The method of claim 1, wherein the substrate is substantially colorless glass.

13. The method of claim 1, wherein the coating material is substantially colorless.

14. The method of claim 1, wherein the substrate is an item of dinnerware.

15. A product comprising:
a transparent substrate;
a portion of decorative material adhered to a bottom side of the transparent substrate to be seen therethrough;
an adhesive soaked into the decorative material to adhere and seal the decorative material to the bottom side of the transparent substrate;
a coating material of transparent, glossy, resilient material, disposed over the decorative material on the bottom side of the substrate which renders the product substantially waterproof in hand washing operations; and
wherein the decorative material appears to be substantially integral with the substrate when viewed through the transparent substrate.

16. The product of claim 15, wherein the decorative material is fabric or paper.

17. The product of claim 15, further comprising glitter material disposed on an upwardly facing side of the decorative material so as to be seen through the transparent substrate.

18. The product of claim 15, wherein the decorative material is a bandana.

19. The product of claim 15, wherein the substrate is an item of dinnerware.

20. The product of claim 15, wherein the substrate is substantially colorless glass.

21. The product of claim 15, wherein the coating material is substantially colorless.

22. The product of claim 15, wherein the coating comprises two layers of transparent, glossy, resilient material, disposed over the decorative material on the bottom side of the substrate.

23. The method of claim 1, further comprising
applying a second coating of transparent, glossy, resilient material over the bottom of the substrate with the decorative material adhered in place; and
allowing the coating material to cure.
